(19) United States
(12) Patent Application Publication
(10) Pub. No.: US 2025/0296407 A1
(43) Pub. Date: Sep. 25, 2025

(54) AIR-CONDITIONING REGISTER

(71) Applicant: TOYODA GOSEI CO., LTD., Kiyosu-shi (JP)

(72) Inventor: Hironori TAKAGI, Kiyosu-shi (JP)

(21) Appl. No.: 19/058,327

(22) Filed: Feb. 20, 2025

(30) Foreign Application Priority Data
Mar. 19, 2024 (JP) 2024-043289
Mar. 19, 2024 (JP) 2024-043290

(51) Int. Cl. B60H 1/34

(52) U.S. Cl. CPC B60H 1/3421; B60H 2001/3478

(57) ABSTRACT

An air-conditioning register includes a retainer that includes a vent passage, and a fin-shaft member. The fin-shaft member includes a shaft that is configured to rotate about an axis extending in a first direction, and a fin. An outer circumferential surface of the shaft includes clearance sections. A direction in which the fin-shaft member and an outlet are arranged is defined as a second direction. A direction orthogonal to both the first direction and the second direction is defined as a third direction. The vent passage includes a first passage portion and a second passage portion respectively located at one side and an other side of the shaft in the third direction. The clearance sections are configured to be located in the first passage portion and the second passage portion when the fin is located at one side or an other side of the shaft in the second direction.

### CROSS-REFERENCE TO RELATED APPLICATIONS

This application is based upon and claims the benefit of priority from Japanese Patent Application No. 2024-043289, filed on Mar. 19, 2024, and Japanese Patent Application No. 2024-043290, filed on Mar. 19, 2024, the entire contents of each of which are incorporated herein by reference.

### BACKGROUND

### 1. Field

The present disclosure relates to an air-conditioning register.

### 2. Description of Related Art

Automobiles are equipped with air-conditioning registers that blow air-conditioning air into the passenger compartments (see, for example, Japanese Laid-Open Patent Publication No. 2009-208496 and Japanese Laid-Open Patent Publication No. 2022-150682).

The vent structure described in Japanese Laid-Open Patent Publication No. 2009-208496 includes a case frame, a rotary shaft member rotatably supported in the case frame, and rotary fin members formed integrally with the rotary shaft member. The rotary fin members are disposed on the rotary shaft member in an inclined manner. By rotating the rotary shaft member, the inclination direction of the rotary fin members is changed, thereby adjusting the airflow direction of the air-conditioning air.

The airflow direction adjusting device described in Japanese Laid-Open Patent Publication No. 2022-150682 includes a tubular case body, multiple intermediate movable fins, and multiple rear fins. The intermediate movable fins and the rear fins are provided inside the case body.

The intermediate movable fins are spaced apart from each other in a Y-direction, which is a plane direction of the opening surface of the outlet.

The rear fins are located at the opposite side of the intermediate movable fins from the outlet.

A direction in which the intermediate movable fins and the outlet are arranged is defined as an X-direction, and a direction orthogonal to both the Y-direction and the X-direction is defined as a Z-direction.

The intermediate movable fins are each supported rotatably about an axis extending in the Z-direction. When the intermediate movable fins rotate, the airflow direction of the air-conditioning air in the Y-direction is changed. A drive mechanism that rotates the intermediate movable fins is provided outside the case body in the Z-direction.

The rear fins are each supported rotatably about an axis extending in the Y-direction. When the rear fins rotate, the airflow direction of the air-conditioning air in the Z-direction is changed. A drive mechanism that rotates the rear fins is provided outside the case body in the Y-direction.

In the vent structure described in Japanese Laid-Open Patent Publication No. 2009-208496, the rotary fin members are provided over the entire circumference of the rotary shaft member. This allows the rotary fin members to change the airflow direction of the air-conditioning air regardless of the phase of the rotary fin members. Accordingly, it is not possible to achieve a neutral state, in which the airflow direction of the air-conditioning air discharged from the outlet remains unchanged.

In the airflow direction adjusting device described in Japanese Laid-Open Patent Publication No. 2022-150682, the drive mechanism that rotates the intermediate movable fins is provided outside the case body in the Z-direction. This makes it difficult to reduce the dimension of the air-conditioning register in the Z-direction, i.e., to achieve a low-profile design.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an air-conditioning register includes a retainer and a fin-shaft member. The retainer includes a vent passage including an outlet configured to blow out air-conditioning air. The fin-shaft member is provided in the retainer. The fin-shaft member includes a shaft and a fin. The shaft is configured to rotate about an axis extending in a first direction. The first direction is a plane direction of an opening surface of the outlet. The fin protrudes from an outer circumferential surface of the shaft and is inclined with respect to an imaginary plane orthogonal to the axis. The outer circumferential surface of the shaft includes clearance sections in a circumferential direction of the shaft. The clearance sections are portions in which the fin is not provided. A direction orthogonal to the first direction, and in which the fin-shaft member and the outlet are arranged, is defined as a second direction. A direction orthogonal to both the first direction and the second direction is defined as a third direction. The vent passage includes a first passage portion and a second passage portion respectively located at one side and an other side of the shaft in the third direction. The clearance sections are configured to be located in the first passage portion and the second passage portion when the fin is located at one side or an other side of the shaft in the second direction.

In another general aspect, an air-conditioning register includes a retainer, a downstream fin-shaft member, an upstream fin-shaft member, and a driving device. The retainer includes a vent passage including an outlet configured to blow out air-conditioning air. The downstream fin-shaft member is provided in the retainer. The upstream fin-shaft member is provided in the retainer. The upstream fin-shaft member is located at an opposite side of the downstream fin-shaft member from the outlet. The downstream fin-shaft member includes a downstream shaft and a downstream fin. The downstream shaft is configured to rotate about a first axis extending in a first direction. The first direction is a plane direction of an opening surface of the outlet. The downstream fin protrudes from an outer circumferential surface of the downstream shaft and is inclined with respect to an imaginary plane orthogonal to the first axis. The upstream fin-shaft member includes an upstream shaft and an upstream fin. The upstream shaft is configured to rotate about a second axis extending in the first direction. The upstream fin extends in the first direction. The driving device is provided at one side of the downstream shaft and the upstream shaft in the first direction, and is configured to rotate the downstream shaft and the upstream shaft.

Other features and aspects will be apparent from the following detailed description, the drawings, and the claims.

### BRIEF DESCRIPTION OF THE DRAWINGS

FIG. 1 is an exploded perspective view of an air-conditioning register according to an embodiment.

FIGS. 2A, 2B, and 2C are front views of a downstream fin-shaft member.

FIG. 3 is a cross-sectional view the air-conditioning register.

FIG. 4 is a cross-sectional view taken along line 4-4 of FIG. 3.

FIG. 5 is a cross-sectional view of the air-conditioning register with both the downstream fin-shaft member and an upstream fin at neutral positions.

FIG. 6 is a front view of the air-conditioning register in the state of FIG. 5.

FIG. 7 is a cross-sectional view of the air-conditioning register in a state in which the upstream fin is at a first airflow-direction control position and first downstream fins are located in a first passage portion.

FIG. 8 is a front view of the air-conditioning register in the state of FIG. 7.

FIG. 9 is a cross-sectional view of the air-conditioning register in a state in which the upstream fin is at the first airflow-direction control position and second downstream fins are located in the first passage portion.

FIG. 10 is a front view of the air-conditioning register in the state of FIG. 9.

FIG. 11 is a cross-sectional view of the air-conditioning register in a state in which the upstream fin is at a second airflow-direction control position and the downstream fin-shaft member is at the neutral position.

FIG. 12 is a cross-sectional view of the air-conditioning register in a state in which the upstream fin is at a blocking position.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An air-conditioning register according to an embodiment will now be described with reference to the drawings.

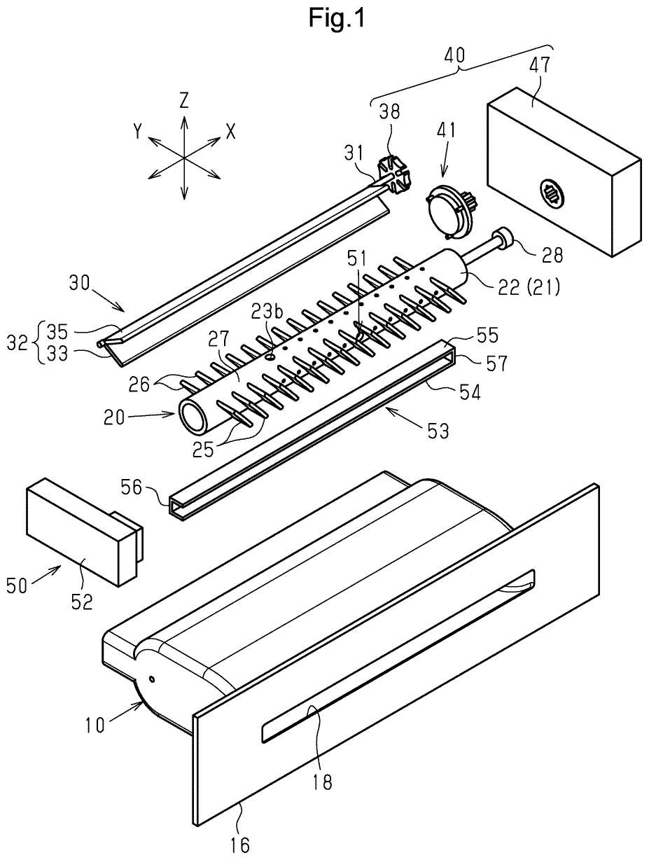

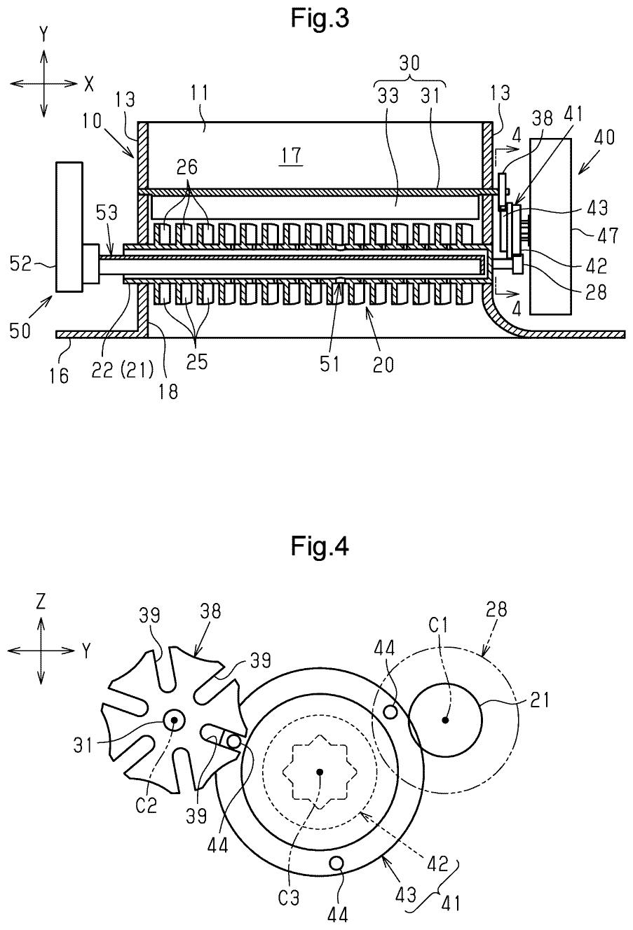

As shown in FIGS. 1 and 3, the air-conditioning register includes a retainer 10, a downstream fin-shaft member 20, an upstream fin-shaft member 30, a driving device 40, and a light emitting device 50. The air-conditioning register of the present embodiment is provided in an instrument panel of an automobile.

In the following description, the width direction of the vehicle in which the air-conditioning register is provided is referred to as a vehicle width direction X, the front-rear direction of the vehicle is simply referred to as a front-rear direction Y, and the vertical direction of the vehicle is simply referred to as a vertical direction Z. The vehicle width direction X, the front-rear direction Y, and the vertical direction Z in the present embodiment correspond to a first direction X, a second direction Y, and a third direction Z, respectively.

Each component of the air-conditioning register of the present embodiment will now be described.

### Retainer 10

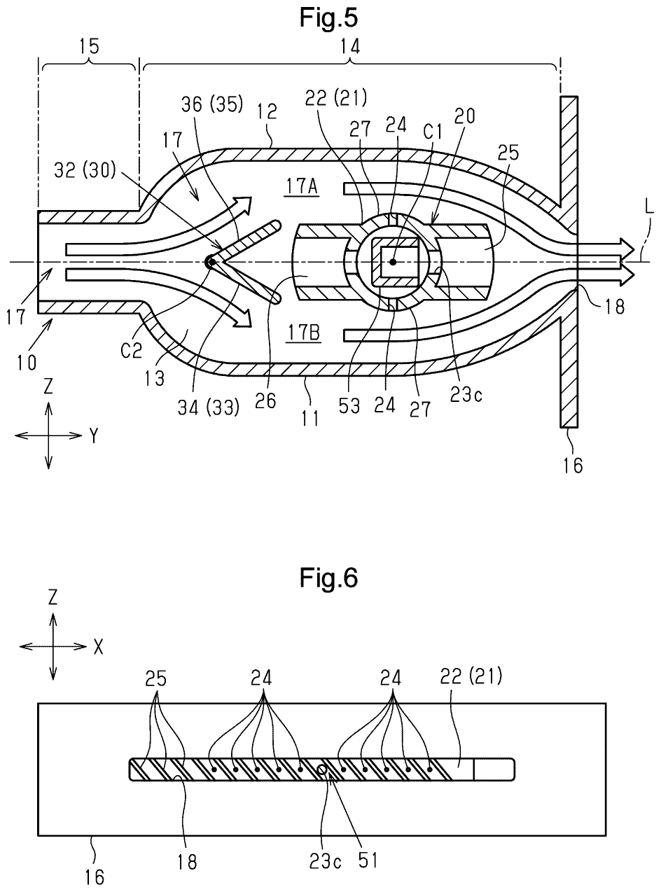

As shown in FIGS. 3 and 5, the retainer 10 includes a vent passage 17 including an outlet 18 configured to blow out air-conditioning air.

As shown in FIG. 5, the retainer 10 includes a lower wall 11, an upper wall 12 located above the lower wall 11, two side walls 13, and a bezel 16. The side walls 13 are located on the opposite sides in the vehicle width direction X and connect the lower wall 11 and the upper wall 12 to each other.

The retainer 10 includes an accommodating portion 14 including the outlet 18, and a connection portion 15 connected to the upstream side of the accommodating portion 14 in the flow direction of the air-conditioning air.

The accommodating portion 14 accommodates a downstream fin-shaft member 20 and an upstream fin 32, which will be discussed below.

The distance between the lower wall 11 and the upper wall 12 in the connection portion 15 is smaller than that in the accommodating portion 14. In other words, the distance between the inner walls of the connection portion 15 that face each other in the third direction Z is smaller than the distance between the inner walls of the accommodating portion 14 facing each other in the third direction Z.

As shown in FIG. 1, the plane direction of the opening surface of the outlet 18 is a direction along both the vehicle width direction X and the vertical direction Z. The outlet 18 has a flat shape in which the dimension in the vertical direction Z is smaller than the dimension in the vehicle width direction X.

As shown in FIG. 5, the outlet 18 is located on an imaginary straight line L that passes through the center of the connection portion 15 in the vertical direction Z and extends in the front-rear direction Y. The width of the outlet 18 in the vertical direction Z is smaller than the width of the connection portion 15 in the vertical direction Z.

The sections of the lower wall 11 and the upper wall 12 that form the connection portion 15 extend in the front-rear direction Y.

The section of the lower wall 11 that forms the accommodating portion 14 is curved upward toward the outlet 18. The section of the upper wall 12 that forms the accommodating portion 14 is curved downward toward the outlet 18.

### Downstream Fin-Shaft Member 20

As shown in FIGS. 1 to 3 and 5, the downstream fin-shaft member 20 is provided in the accommodating portion 14 of the retainer 10.

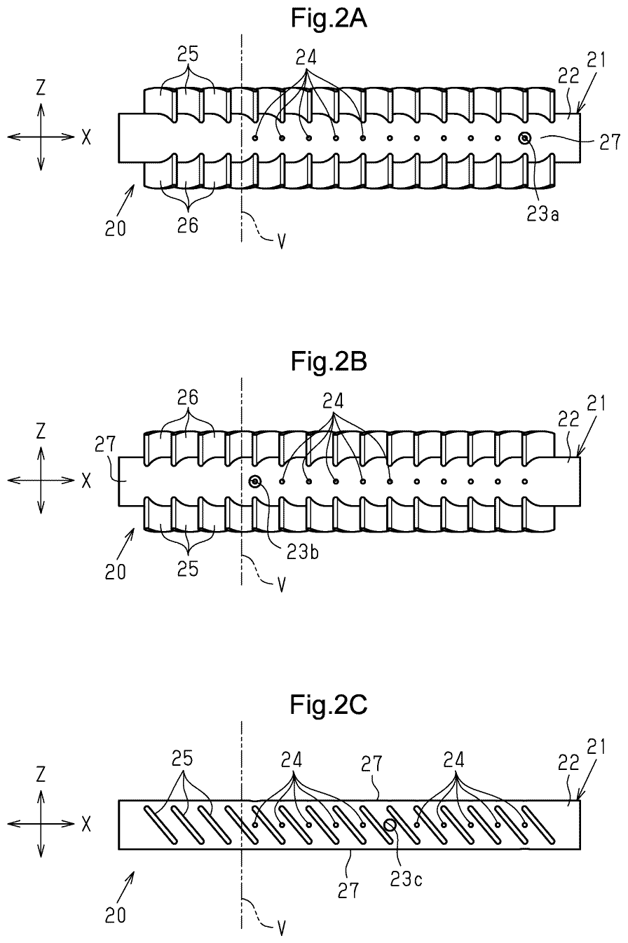

As shown in FIGS. 2A to 2C, the downstream fin-shaft member 20 includes a downstream shaft 21, first downstream fins 25, and second downstream fins 26.

As shown in FIG. 5, the downstream shaft 21 is configured to rotate about a first axis C1 extending in the vehicle width direction X.

As shown in FIGS. 1 to 3 and 5, the downstream shaft 21 includes a tubular peripheral wall 22 extending in the first direction X.

As shown in FIGS. 2A to 2C, the first downstream fins 25 protrude from the outer circumferential surface of the downstream shaft 21 and are inclined with respect to an imaginary plane V orthogonal to the first axis C1.

The second downstream fins 26 protrude from a portion of the outer circumferential surface of the downstream shaft 21, and are located on the opposite side of the downstream shaft 21 from the first downstream fins 25.

The second downstream fins 26 are inclined in the same direction as the first downstream fins 25 with respect to the imaginary plane V.

In the present embodiment, the first downstream fins 25 are spaced apart from each other in the vehicle width direction X. Similarly, the second downstream fins 26 are spaced apart from each other in the vehicle width direction X.

The outer circumferential surface of the downstream shaft 21 includes clearance sections 27 in the circumferential direction of the downstream shaft 21. The clearance sections 27 are portions in which neither the first downstream fins 25 nor the second downstream fins 26 are provided. The clearance sections 27 are provided between the first downstream fins 25 and the second downstream fins 26 in the circumferential direction of the downstream shaft 21 on the outer circumferential surface of the downstream shaft 21.

As shown in FIG. 5, the vent passage 17 includes a first passage portion 17A and a second passage portion 17B located above and below the downstream shaft 21, respectively.

The clearance sections 27 are configured to be located in the first passage portion 17A and the second passage portion 17B when the first downstream fins 25 and the second downstream fins 26 are located on the front side or the rear side of the downstream shaft 21.

As shown in FIGS. 1, 3, and 4, a downstream driven gear 28 is provided at one end of the downstream shaft 21. The downstream driven gear 28 is a spur gear.

### Upstream Fin-Shaft Member 30

As shown in FIGS. 1, 3, and 5, the upstream fin-shaft member 30 is provided in front of the downstream fin-shaft member 20 in the retainer 10. In other words, the upstream fin-shaft member 30 is provided in the retainer 10 and is located at the opposite side of the downstream fin-shaft member 20 from the outlet 18.

As shown in FIG. 5, the upstream fin-shaft member 30 includes an upstream shaft 31 having a second axis C2 extending in the first direction X, and an upstream fin 32 configured to rotate about the second axis C2.

The upstream fin 32 has a first surface 34 and a second surface 36, which extend in the first direction X.

The upstream fin 32 includes a first upstream fin member 33 and a second upstream fin member 35, which have the shapes of flat plates. The first upstream fin member 33 and the second upstream fin member 35 each protrude from the upstream shaft 31 in a radial direction of the upstream shaft 31. The angle formed by the first upstream fin member 33 and the second upstream fin member 35 is, for example, 60 degrees. Of the two main surfaces of the first upstream fin member 33, the surface on the side away from the second upstream fin member 35 forms the first surface 34. Of the two main surfaces of the second upstream fin member 35, the surface on the side away from the first upstream fin member 33 forms the second surface 36.

The upstream fin 32 is configured to be displaced to a first airflow-direction control position, a second airflow-direction control position, a neutral position, and a blocking position.

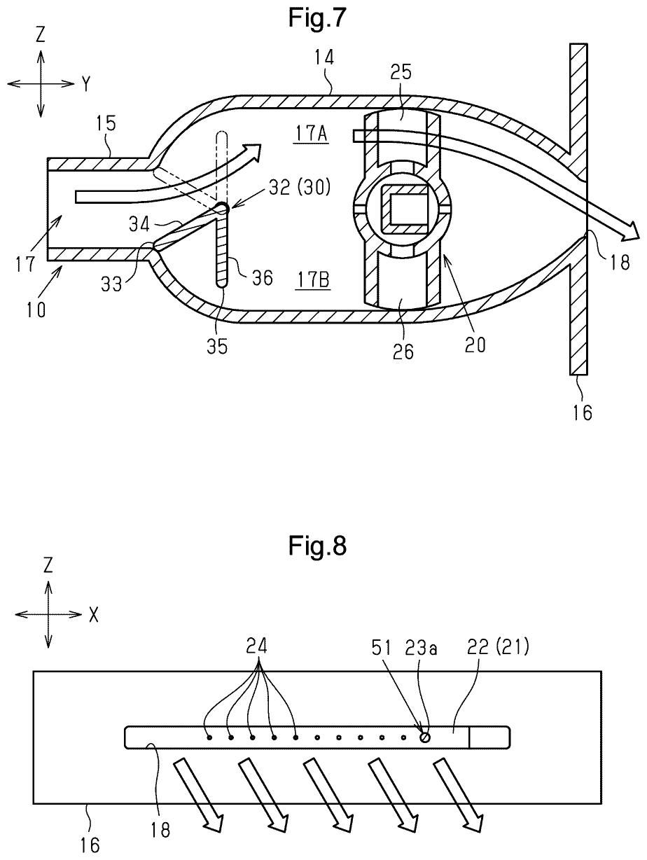

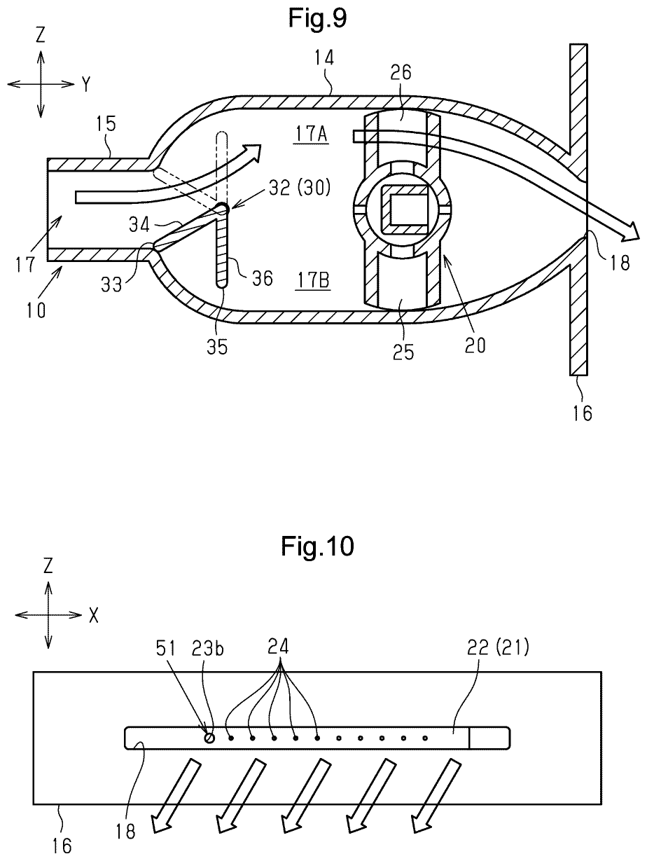

As shown in FIGS. 7 and 9, the first airflow-direction control position is a position at which the upstream fin 32 guides the flow of the air-conditioning air to the first passage portion 17A and restricts the flow of the air-conditioning air to the second passage portion 17B. At the first airflow-direction control position, only the second surface 36 of the first surface 34 and the second surface 36 is inclined with respect to the second direction Y so as to extend from the connection portion 15 toward the first passage portion 17A.

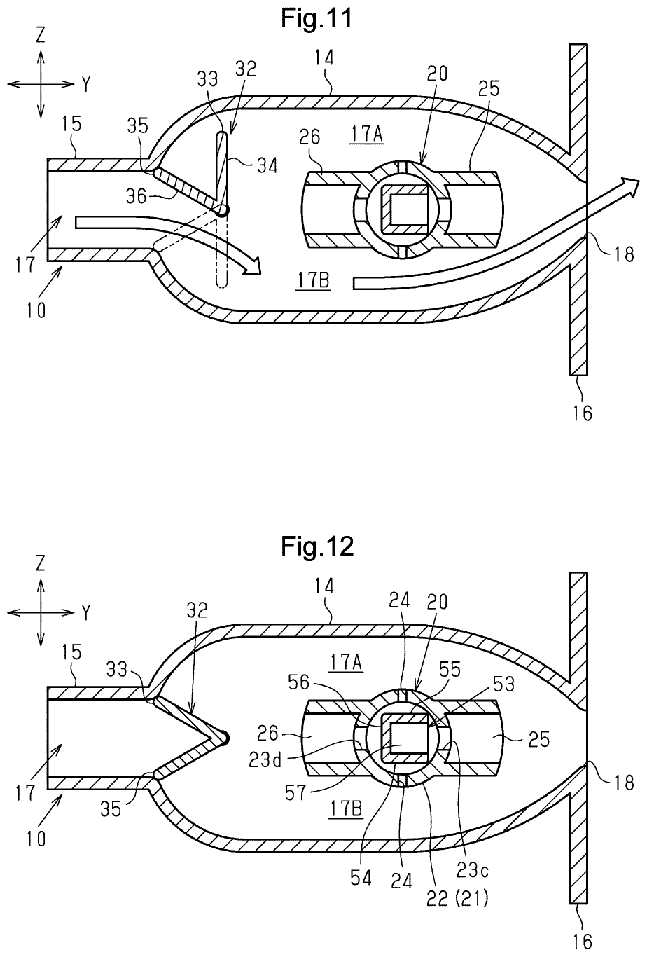

As shown in FIG. 11, the second airflow-direction control position is a position at which the upstream fin 32 guides the flow of the air-conditioning air to the second passage portion 17B and restricts the flow of the air-conditioning air to the first passage portion 17A. At the second airflow-direction control position, only the first surface 34 of the first surface 34 and the second surface 36 is inclined with respect to the second direction Y so as to extend from the connection portion 15 toward the second passage portion 17B.

As shown in FIG. 5, the neutral position is a position at which the upstream fin 32 guides the flow of the air-conditioning air to both the first passage portion 17A and the second passage portion 17B. At the neutral position, the second surface 36 is inclined with respect to the second direction Y so as to extend from the connection portion 15 toward the first passage portion 17A, and the first surface 34 is inclined with respect to the second direction Y so as to extend from the connection portion 15 toward the second passage portion 17B.

As shown in FIG. 12, the blocking position is a position at which the upstream fin 32 blocks the vent passage 17.

As shown in FIGS. 1, 3, and 4, an upstream driven gear 38 is provided at one end of the upstream shaft 31.

As shown in FIG. 4, the upstream driven gear 38 has multiple slots 39 extending in radial directions of the upstream driven gear 38. The multiple slots 39 are provided at equal intervals in the circumferential direction of the upstream driven gear 38. In the present embodiment, six slots 39 are provided at equal intervals (intervals of 60 degrees) in the circumferential direction of the upstream driven gear 38.

### Driving Device 40

As shown in FIGS. 1 and 3, the driving device 40 rotates the downstream fin-shaft member 20 and the upstream fin-shaft member 30. The driving device 40 is provided outside the retainer 10.

The driving device 40 is provided at one side of the downstream shaft 21 and the upstream shaft 31 in the vehicle width direction X.

The driving device 40 includes a motor 47 and a common drive gear set 41, which is rotated by the motor 47 to transmit the rotational force to each of the downstream shaft 21 and the upstream shaft 31.

As shown in FIG. 4, the drive gear set 41 is rotated about a third axis C3 extending in the vehicle width direction X.

The drive gear set 41 includes a downstream driving gear 42, which meshes with the downstream driven gear 28 so as to continuously rotates the downstream driven gear 28. The downstream driving gear 42 is a spur gear centered on the third axis C3.

The drive gear set 41 includes an upstream driving gear 43. The upstream driving gear 43 is centered on the third axis C3 and has multiple pins 44, which enter the slots 39 of the upstream driven gear 38 to intermittently rotate the upstream driven gear 38. The upstream driving gear 43 and the upstream driven gear 38 together form a Geneva mechanism. In the present embodiment, three pins 44 are provided at equal intervals (intervals of 120 degrees) in the circumferential direction of the upstream driving gear 43.

When the drive gear set 41 rotates, the downstream driven gear 28 is configured to rotate continuously via the downstream driving gear 42, while the pins 44 of the upstream driving gear 43 engage with the slots 39 of the upstream driven gear 38, causing the upstream driven gear 38 to rotate intermittently in 60-degree increments.

In the present embodiment, the drive gear set 41, which includes the downstream driving gear 42 and the upstream driving gear 43, the downstream driven gear 28, and the upstream driven gear 38 form an interlocking mechanism that coordinates rotational displacement of the downstream fin-shaft member 20 and rotational displacement of the upstream fin 32 with each other.

### Light Emitting Device 50

As shown in FIGS. 1 and 3, the light emitting device 50 includes multiple light emitting display portions 51 and a light source 52, which causes the light emitting display portions 51 to emit light.

The light source 52 includes a light-emitting element such as an LED, and is located outside the retainer 10. The light source 52 is located outside the peripheral wall 22 of the downstream fin-shaft member 20. In the present embodiment, the light source 52 is provided at the side opposite to the driving device 40 in the vehicle width direction X. In the present embodiment, the light source 52 is energized to emit light while the air conditioner is operating.

The light emitting device 50 includes a light guide 53, which is provided inside the peripheral wall 22 and guides light emitted from the light source 52 to the interior of the peripheral wall 22.

As shown in FIGS. 1 and 12, the light guide 53 includes a lower wall 54, an upper wall 55, a front wall 56, and a side wall 57.

The lower wall 54 and the upper wall 55 face each other in the vertical direction Z and extend in parallel in the vehicle width direction X. The front wall 56 connects the front edge of the lower wall 54 and the front edge of the upper wall 55 to each other, and extends in the vehicle width direction X. The side wall 57 is provided at one end of the light guide 53 at a side opposite to the light source 52 in the vehicle width direction X.

The light guide 53 opens rearward and toward the light source 52.

The light emitting display portions 51 are provided in the downstream shaft 21, are visible through the outlet 18, and display the airflow direction of the air-conditioning air. The light emitting display portions 51 are light transmitting portions 23a to 23d, which are provided in the peripheral wall 22 of the downstream shaft 21 and transmit the light from the light guide 53. The light transmitting portions 23a to 23d of the present embodiment are holes extending through the peripheral wall 22.

As shown in FIGS. 2A to 2C, the light transmitting portions 23a to 23d are provided at different positions in the circumferential direction of the peripheral wall 22. In the present embodiment, four light transmitting portions 23a to 23d are provided at equal intervals, that is, at 90-degree intervals in the circumferential direction.

As shown in FIG. 2A, the light transmitting portion 23a is provided in one of the two clearance sections 27 located between the first downstream fins 25 and the second downstream fins 26. More specifically, the light transmitting portion 23a is provided in the clearance section 27 that is oriented toward the outlet 18 when the first downstream fins 25 and the second downstream fins 26 are located in the first passage portion 17A and the second passage portion 17B, respectively. The light transmitting portion 23a is provided at one side (right side in FIG. 2A) in the vehicle width direction X. In the present embodiment, multiple auxiliary holes 24 having diameters smaller than that of the light transmitting portion 23a are provided side by side with the light transmitting portion 23a in the vehicle width direction X. The auxiliary holes 24 are provided at the other side (the left side in FIG. 2A) in the vehicle width direction X with respect to the light transmitting portion 23a. The diameters of the auxiliary holes 24 are preferably less than or equal to half the diameter of the light transmitting portion 23a.

As shown in FIG. 2B, the light transmitting portion 23b is provided in the other one of the two clearance sections 27 located between the first downstream fins 25 and the second downstream fins 26. More specifically, the light transmitting portion 23b is provided in the clearance section 27 that is oriented toward the outlet 18 when the first downstream fins 25 and the second downstream fins 26 are located in the second passage portion 17B and the first passage portion 17A, respectively. The light transmitting portion 23b is provided at the other side (left side in FIG. 2A) in the vehicle width direction X. In the present embodiment, multiple auxiliary holes 24 having diameters smaller than that of the light transmitting portion 23b are provided side by side with the light transmitting portion 23b in the vehicle width direction X. The auxiliary holes 24 are provided on one side of the light transmitting portion 23b (the right side in FIG. 2A) in the vehicle width direction X. The diameters of the auxiliary holes 24 are preferably less than or equal to half the diameter of the light transmitting portion 23b.

As shown in FIGS. 2C and 12, the light transmitting portion 23c is provided between two of the first downstream fins 25. The light transmitting portion 23c is provided at an intermediate position between the light transmitting portion 23a and the light transmitting portion 23b in the vehicle width direction X. In the present embodiment, multiple auxiliary holes 24 having diameters smaller than that of the light transmitting portion 23c are provided side by side with the light transmitting portion 23c in the vehicle width direction X. The auxiliary holes 24 are provided on both sides of the light transmitting portion 23c in the vehicle width direction X. The diameters of the auxiliary holes 24 are preferably less than or equal to half the diameter of the light transmitting portion 23c.

As shown in FIG. 12, the light transmitting portion 23d is provided between two of the second downstream fins 26. The light transmitting portion 23d is provided at an intermediate position between the light transmitting portion 23a and the light transmitting portion 23b in the vehicle width direction X. In the present embodiment, multiple auxiliary holes 24 having diameters smaller than that of the light transmitting portion 23d are provided side by side with the light transmitting portion 23d in the vehicle width direction X. The auxiliary holes 24 are provided on both sides of the light transmitting portion 23d in the vehicle width direction X. The diameters of the auxiliary holes 24 are preferably less than or equal to half the diameter of the light transmitting portion 23c.

The positions of the light transmitting portions 23a to 23d in the vehicle-width direction X when the light transmitting portions 23a to 23d are located at positions facing the outlet 18 in the front-rear direction Y correspond to the airflow direction in the vehicle-width direction X of the air-conditioning air blown out through the outlet 18.

Next, the relationship of the positions of the downstream fin-shaft member 20 and the upstream fin-shaft member 30 with the airflow direction of the air-conditioning air blown out from the outlet 18 and the display mode of the light emitting display portions 51 will be described.

### When the Upstream Fin-Shaft Member 30 is at the Neutral Position, and the Downstream Fin-Shaft Member 20 is at the Neutral Position

As shown in FIG. 5, when the air-conditioning air flows into the accommodating portion 14 from the connection portion 15, the air-conditioning air flows into the first passage portion 17A and the second passage portion 17B along the second surface 36 and the first surface 34 of the upstream fin 32, respectively. Then, the air-conditioning air is blown out from the outlet 18 without any changes in the airflow direction when flowing through the first passage portion 17A and the second passage portion 17B.

Further, in the example shown in FIG. 6, one of the light emitting display portions 51 that is visually recognized through the outlet 18 is located at the center of the outlet 18 in the vehicle width direction X.

### When the Upstream Fin-Shaft Member 30 is at the First Airflow-Direction Control Position and the First Downstream Fins 25 of the Downstream Fin-Shaft Member 20 is in the First Passage Portion 17A

As shown in FIG. 7, when the air-conditioning air flows into the accommodating portion 14 from the connection portion 15, the air-conditioning air flows into the first passage portion 17A along the first surface 34 of the upstream fin 32. Then, the air-conditioning air flowing through the first passage portion 17A flows along the first downstream fins 25 when passing through the first downstream fins 25.

Accordingly, as shown in FIG. 8, the direction of the air-conditioning air blown out through the outlet 18 is changed to one side in the first direction X (the right side in FIG. 8), and the air-conditioning air is blown out downward.

Further, one of the light emitting display portions 51 that is visually recognized through the outlet 18 is located at one side (the right side in FIG. 8) of the outlet 18 in the vehicle width direction X.

### When the Upstream Fin-Shaft Member 30 is at the Second Airflow-Direction Control Position and the First Downstream Fins 25 of the Downstream Fin-Shaft Member 20 is in the First Passage Portion 17A

As indicated by the long-dash double-short-dash lines in FIG. 7, when the air-conditioning air flows through the second passage portion 17B, the direction of the air-conditioning air is changed by the second downstream fins 26. Accordingly, the direction of the air-conditioning air blown out through the outlet 18 is changed to one side in the first direction X (the right side in FIG. 8), and the air-conditioning air is blown out upward.

### When the Upstream Fin-Shaft Member 30 is at the First Airflow-Direction Control Position and the Second Downstream Fins 26 of the Downstream Fin-Shaft Member 20 is in the First Passage Portion 17A

As shown in FIG. 9, when the air-conditioning air flows into the accommodating portion 14 from the connection portion 15, the air-conditioning air flows into the first passage portion 17A along the first surface 34 of the upstream fin 32. Then, the air-conditioning air flowing through the first passage portion 17A flows along the second downstream fins 26 when passing through the second downstream fins 26.

Accordingly, as shown in FIG. 10, the direction of the air-conditioning air blown out through the outlet 18 is changed to the other side in the first direction X (the left side in FIG. 10), and the air-conditioning air is blown out downward.

Further, one of the light emitting display portions 51 that is visually recognized through the outlet 18 is located at one side (the left side in FIG. 10) of the outlet 18 in the vehicle width direction X.

### When the Upstream Fin-Shaft Member 30 is at the Second Airflow-Direction Control Position and the Second Downstream Fins 26 of the Downstream Fin-Shaft Member 20 is in the First Passage Portion 17A

As indicated by the long-dash double-short-dash lines in FIG. 9, when the air-conditioning air flows through the second passage portion 17B, the direction of the air-conditioning air is changed by the first downstream fins 25. Accordingly, the direction of the air-conditioning air blown out through the outlet 18 is changed to the other side in the first direction X (the left side in FIG. 8), and the air-conditioning air is blown out upward.

When the Upstream Fin-Shaft Member 30 is at the Second Airflow-Direction Control Position, and the Downstream Fin-Shaft Member 20 is at the Neutral Position

As shown in FIG. 11, when the air-conditioning air flows into the accommodating portion 14 from the connection portion 15, the air-conditioning air flows into the second passage portion 17B along the second surface 36 of the upstream fin 32. Then, the air-conditioning air is blown out from the outlet 18 without any changes in the airflow direction when flowing through the second passage portion 17B.

As shown by the long-dash double-short-dash lines in FIG. 11, when the upstream fin-shaft member 30 is at the first airflow-direction control position, the air-conditioning air is blown out downward from the outlet 18 without any changes in the airflow direction when flowing through the first passage portion 17A.

### When the Upstream Fin-Shaft Member 30 is at the Blocking Position, and the Downstream Fin-Shaft Member 20 is at the Neutral Position

As shown in FIG. 12, when blocking the vent passage 17, the upstream fin 32 stops the inflow of the air-conditioning air from the connection portion 15 into the accommodating portion 14. Accordingly, the air-conditioning air is not blown out through the outlet 18. A first operation of the present embodiment will now be described.

As shown in FIG. 7, when the first downstream fins 25 are located in the first passage portion 17A, the air-conditioning air flowing through the first passage portion 17A flows along the first downstream fins 25 when passing through the first downstream fins 25. Accordingly, the airflow direction of the air-conditioning air blown out through the outlet 18 is changed to one side in the first direction X.

Also, as indicated by the long-dash double-short-dash lines in FIG. 9, when the first downstream fins 25 are located in the second passage portion 17B, the air-conditioning air flowing through the second passage portion 17B flows along the first downstream fins 25 when passing through the first downstream fins 25. The inclination direction of the first downstream fins 25 when located in the second passage portion 17B is opposite to the inclination direction of the first downstream fins 25 when located in the first passage portion 17A. Accordingly, the airflow direction of the air-conditioning air blown out through the outlet 18 is changed to the other side in the first direction X.

Further, the outer circumferential surface of the downstream shaft 21 is provided with the clearance sections 27 in the circumferential direction of the downstream shaft 21. The first downstream fins 25 are not provided in the clearance sections 27.

As shown in FIG. 5, when the first downstream fins 25 are located on one side or the other side of the downstream shaft 21 in the second direction Y, the clearance sections 27 are located in the first passage portion 17A and the second passage portion 17B. At this time, the air-conditioning air is blown out from the outlet 18 without any changes in the airflow direction when flowing through the first passage portion 17A and the second passage portion 17B. When the downstream fin-shaft member 20 is at the neutral position, the first downstream fins 25 are not located in the first passage portion 17A or the second passage portion 17B. This suppresses an increase in pressure loss.

A second operation of the present embodiment will now be described.

The driving device 40, which rotates the downstream shaft 21 and the upstream shaft 31, is provided at one side of the downstream shaft 21 and the upstream shaft 31 in the first direction X. This suppresses an increase in the dimension of the air-conditioning register in the third direction Z due to the driving device 40.

The present embodiment has the following advantages.

(1-1) Since the first operation of the above-described embodiment is achieved, it is possible to switch between a state in which the airflow direction of the air-conditioning air blown out from the outlet 18 is changed and a state in which the airflow direction is not changed.

(1-2) When the first downstream fins 25 are located in the first passage portion 17A, the second downstream fins 26 are located in the second passage portion 17B. Therefore, the air-conditioning air flowing through the first passage portion 17A flows along the first downstream fins 25 when passing through the first downstream fins 25, and the air-conditioning air flowing through the second passage portion 17B flows along the second downstream fins 26 when passing through the second downstream fins 26. The second downstream fins 26 have the same inclination direction with respect to the imaginary plane V as the first downstream fins 25. Accordingly, the airflow direction of the air-conditioning air blown out through the outlet 18 is changed to one side in the first direction X.

When the second downstream fins 26 are located in the first passage portion 17A, the first downstream fins 25 are located in the second passage portion 17B. Therefore, the air-conditioning air flowing through the first passage portion 17A flows along the second downstream fins 26 when passing through the second downstream fins 26, and the air-conditioning air flowing through the second passage portion 17B flows along the first downstream fins 25 when passing through the first downstream fins 25. The inclination direction of the second downstream fins 26 when located in the first passage portion 17A is opposite to the inclination direction of the second downstream fins 26 when located in the second passage portion 17B. Accordingly, the airflow direction of the air-conditioning air blown out through the outlet 18 is changed to the other side in the first direction X.

Therefore, the direction of either the air-conditioning air flowing through the first passage portion 17A or the air-conditioning air flowing through the second passage portion 17B can be changed to either side in the first direction X.

(1-3) Displacement of the upstream fin 32 to either the first airflow-direction control position, the second airflow-direction control position, or the neutral position changes the passage portion through which the air-conditioning air flows between the first passage portion 17A and the second passage portion 17B.

Since the downstream fin-shaft member 20 is provided in the retainer 10, the air-conditioning air collides with the downstream shaft 21, which may increase the pressure loss.

In this regard, according to the above-described configuration, the upstream fin 32 guides the flow of the air-conditioning air to one or both the first passage portion 17A and the second passage portion 17B. Accordingly, the air-conditioning air is prevented from colliding with the downstream shaft 21. An increase in pressure loss is thus prevented.

(1-4) The drive gear set 41, which forms an interlocking mechanism, coordinates rotational displacement of the downstream fin-shaft member 20 and rotational displacement of the upstream fin 32 with each other. This simplifies the configuration of the air-conditioning register.

(1-5) The upstream fin 32 is rotated about the second axis C2, which extends in the first direction X. This allows the upstream fin 32 to be displaced to the first airflow-direction control position, the second airflow-direction control position, and the neutral position.

(1-6) Blocking the vent passage 17 with the upstream fin 32 prevents the air-conditioning air from being blown out through the outlet 18.

(2-1) Since the second operation of the above-described embodiment is achieved, the air-conditioning register can made to have a low-profile design.

(2-2) The downstream shaft 21 and the upstream shaft 31 can be rotated by the common drive gear set 41. It is thus possible to coordinate rotational displacement of the downstream fin-shaft member 20 and rotational displacement of the upstream fin-shaft member 30 with each other. This reduces the number of components of the driving device 40.

(3-1) When the light emitting display portions 51, provided in the downstream shaft 21, emit light, the user can recognize the airflow direction of the air-conditioning air by visually observing the light emitting display portion 51 through the outlet 18. This improves the visibility of the portion displaying the airflow direction of the air-conditioning air, even when the width of the outlet 18 is small.

(3-2) The light emitted from the light source 52 is guided to the interior of the peripheral wall 22 through the light guide 53, and is radiated to the outside of the downstream shaft 21 through the light transmitting portions 23a to 23d provided in the peripheral wall 22. Therefore, the light transmitting portions 23a to 23d provided in the peripheral wall 22 of the downstream shaft 21 emit light even though the light source 52 is provided outside the downstream fin-shaft member 20.

(3-3) The user can intuitively recognize the airflow direction of the air-conditioning air in the first direction X by observing the position of the light transmitting portions 23a to 23d in the first direction X through the outlet 18.

(3-4) The light transmitting portions 23a to 23d are holes that extend through the peripheral wall 22. Therefore, the light transmitting portions 23a to 23d can be implemented with a simple configuration.

### Modifications

The above-described embodiment may be modified as follows. The above-described embodiment and the following modifications can be combined as long as the combined modifications remain technically consistent with each other.

The auxiliary holes 24 may be omitted.

The light transmitting portions 23c and 23d may be omitted.

The light transmitting portions 23a to 23d are not limited to holes extending through the peripheral wall 22. The light transmitting portions 23a to 23d can also be embodied by forming a part of the peripheral wall 22 with a visible light transmissive material.

In the above-described embodiment, the light transmitting portions 23a to 23d may be provided at the same position in the vehicle width direction X. In this case, the shape of the light transmitting portions 23a and 23b may be an arrow shape indicating the airflow direction of the air-conditioning air.

A light source may be disposed inside the peripheral wall 22. In this case, the light guide 53 can be omitted.

In the above-described embodiment, the light emitting display portions 51 are provided in the downstream shaft 21. However, the light emitting display portions 51 may be provided in the downstream fins (the first downstream fins 25 and the second downstream fins 26) in addition to or instead of the downstream shaft 21.

The light emitting device 50 may be omitted.

The number of the slots 39 of the upstream driven gear 38 and the number of the pins 44 of the upstream driving gear 43 may be changed.

The upstream fin 32 does not necessarily need to be displaced to the blocking position.

The driving device 40 is not limited to a device including the drive gear set 41. Alternatively, for example, the downstream fin-shaft member 20 and the upstream fin-shaft member 30 may be driven by different motors. In other words, it is possible to omit the interlocking mechanism that coordinates rotational displacement of the downstream fin-shaft member 20 and rotational displacement of the upstream fin 32 with each other.

The upstream fin 32 may be omitted. In this case, the first downstream fins 25 each act as a first fin, and the second downstream fins 26 each act as a second fin.

The second downstream fins 26 may be omitted.

The clearance sections 27 may be omitted. In other words, downstream fins may be provided over the entire circumference of the outer circumferential surface of the downstream shaft 21.

The outlet 18 may be formed in a flat shape in which the dimension in the vehicle width direction X is smaller than the dimension in the vertical direction Z. In this case, it is sufficient to modify the configuration of the air-conditioning register such that the vertical direction Z is defined as the first direction, and the vehicle width direction X is defined as the third direction.

The air-conditioning register is not limited to being installed in the instrument panel but may also be installed in the console box, ceiling, or other locations.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An air-conditioning register, comprising:
a retainer that includes a vent passage including an outlet configured to blow out air-conditioning air; and
a fin-shaft member provided in the retainer, wherein
the fin-shaft member includes:
a shaft that is configured to rotate about an axis extending in a first direction, the first direction being a plane direction of an opening surface of the outlet; and
a fin that protrudes from an outer circumferential surface of the shaft and is inclined with respect to an imaginary plane orthogonal to the axis,
the outer circumferential surface of the shaft includes clearance sections in a circumferential direction of the shaft, the clearance sections being portions in which the fin is not provided,
a direction orthogonal to the first direction, and in which the fin-shaft member and the outlet are arranged, is defined as a second direction,
a direction orthogonal to both the first direction and the second direction is defined as a third direction,
the vent passage includes a first passage portion and a second passage portion respectively located at one side and an other side of the shaft in the third direction, and
the clearance sections are configured to be located in the first passage portion and the second passage portion when the fin is located at one side or an other side of the shaft in the second direction.

2. The air-conditioning register according to claim 1, wherein
the fin is a first fin,
the fin-shaft member includes a second fin that protrudes from a portion of the outer circumferential surface of the shaft, the second fin being located on an opposite side of the shaft from the first fin, and
the second fin is inclined in a same direction as the first fin with respect to the imaginary plane.

3. The air-conditioning register according to claim 1, wherein
the fin-shaft member, the shaft, and the fin are respectively a downstream fin-shaft member, a downstream shaft, and a downstream fin,
the air-conditioning register further comprises an upstream fin provided in the retainer, the upstream fin being located at an opposite side of the downstream fin-shaft member from the outlet and configured to rotate about an axis extending in the first direction, and
the upstream fin is configured to be displaced to
a first airflow-direction control position at which the upstream fin guides a flow of the air-conditioning air to the first passage portion and restricts the flow of the air-conditioning air to the second passage portion,
a second airflow-direction control position at which the upstream fin guides the flow of the air-conditioning air to the second passage portion and restricts the flow of the air-conditioning air to the first passage portion, and
a neutral position at which the upstream fin guides the flow of the air-conditioning air to both the first passage portion and the second passage portion.

4. The air-conditioning register according to claim 3, further comprising an interlocking mechanism that coordinates rotational displacement of the downstream fin-shaft member and rotational displacement of the upstream fin with each other.

5. The air-conditioning register according to claim 3, wherein
the upstream fin includes a first surface and a second surface that extend in the first direction, and is configured to rotate about an axis extending in the first direction,
the retainer includes:
an accommodating portion that accommodates the downstream fin-shaft member and the upstream fin and includes the outlet; and
a connection portion that is connected to an upstream side of the accommodating portion in a flow direction of the air-conditioning air,
a distance between inner walls of the connection portion that face each other in the third direction is smaller than a distance between inner walls of the accommodating portion facing each other in the third direction,
at the first airflow-direction control position, only the first surface of the first surface and the second surface is inclined with respect to the second direction so as to extend from the connection portion toward the first passage portion,
at the second airflow-direction control position, only the second surface of the first surface and the second surface is inclined with respect to the second direction so as to extend from the connection portion toward the second passage portion, and
at the neutral position, the second surface is inclined with respect to the second direction so as to extend from the connection portion toward the first passage portion, and the first surface is inclined with respect to the second direction so as to extend from the connection portion toward the second passage portion.

6. The air-conditioning register according to claim 3, wherein the upstream fin is configured to be displaced to a blocking position at which the upstream fin blocks the vent passage.

7. An air-conditioning register, comprising:
a retainer that includes a vent passage including an outlet configured to blow out air-conditioning air;
a downstream fin-shaft member provided in the retainer;
an upstream fin-shaft member provided in the retainer, the upstream fin-shaft member being located at an opposite side of the downstream fin-shaft member from the outlet; and
a driving device, wherein
the downstream fin-shaft member includes:
a downstream shaft that is configured to rotate about a first axis extending in a first direction, the first direction being a plane direction of an opening surface of the outlet; and
a downstream fin that protrudes from an outer circumferential surface of the downstream shaft and is inclined with respect to an imaginary plane orthogonal to the first axis,
the upstream fin-shaft member includes:
an upstream shaft that is configured to rotate about a second axis extending in the first direction; and
an upstream fin extending in the first direction, and
the driving device is provided at one side of the downstream shaft and the upstream shaft in the first direction, and is configured to rotate the downstream shaft and the upstream shaft.

8. The air-conditioning register according to claim 7, wherein the driving device includes a common drive gear set that transmits a rotational force to each of the downstream shaft and the upstream shaft.

9. The air-conditioning register according to claim 7, wherein
the outer circumferential surface of the downstream shaft includes clearance sections in a circumferential direction of the downstream shaft, the clearance sections being portions in which the downstream fin is not provided,
a direction orthogonal to the first direction and in which the downstream fin-shaft member and the outlet are arranged is defined as a second direction,
a direction orthogonal to both the first direction and the second direction is defined as a third direction,
the vent passage includes a first passage portion and a second passage portion respectively located at one side and an other side of the downstream shaft in the third direction, and
the clearance sections are configured to be located in the first passage portion and the second passage portion when the downstream fin is located at one side or an other side of the downstream shaft in the second direction.

10. The air-conditioning register according to claim 9, wherein
the downstream fin is a first downstream fin,
the downstream fin-shaft member includes a second downstream fin that protrudes from a portion of the outer circumferential surface of the downstream shaft on an opposite side of the downstream shaft from the first downstream fin, and
the second downstream fin is inclined in a same direction as the first downstream fin with respect to the imaginary plane.

11. The air-conditioning register according to claim 9, wherein
the upstream fin is configured to be displaced to
a first airflow-direction control position at which the upstream fin guides a flow of the air-conditioning air to the first passage portion and restricts the flow of the air-conditioning air to the second passage portion,
a second airflow-direction control position at which the upstream fin guides the flow of the air-conditioning air to the second passage portion and restricts the flow of the air-conditioning air to the first passage portion, and
a neutral position at which the upstream fin guides the flow of the air-conditioning air to both the first passage portion and the second passage portion.

12. The air-conditioning register according to claim 11, wherein
the upstream fin includes a first surface and a second surface that extend in the first direction,
the retainer includes:
an accommodating portion that accommodates the downstream fin-shaft member and the upstream fin and includes the outlet; and
a connection portion that is connected to an upstream side of the accommodating portion in a flow direction of the air-conditioning air,
a distance between inner walls of the connection portion that face each other in the third direction is smaller than a distance between inner walls of the accommodating portion facing each other in the third direction,
at the first airflow-direction control position, only the first surface of the first surface and the second surface is inclined with respect to the second direction so as to extend from the connection portion toward the first passage portion,
at the second airflow-direction control position, only the second surface of the first surface and the second surface is inclined with respect to the second direction so as to extend from the connection portion toward the second passage portion, and
at the neutral position, the second surface is inclined with respect to the second direction so as to extend from the connection portion toward the first passage portion, and the first surface is inclined with respect to the second direction so as to extend from the connection portion toward the second passage portion.

13. The air-conditioning register according to claim 11, wherein the upstream fin is configured to be displaced to a blocking position at which the upstream fin blocks the vent passage.
